(19) United States
(12) Patent Application Publication
(10) Pub. No.: US 2006/0202536 A1
(43) Pub. Date: Sep. 14, 2006

(54) Chair with self-adjusting chair back

(75) Inventors: Robert James Luchetti, Cambridge, MA (US); Matthew John Bushey, Arlington, MA (US); David Alfred Brothers, Radford, VA (US)

Correspondence Address: JOHN C. GORECKI, ESQ., P.O BOX 553, CARLISLE, MA, 01741, US

(73) Assignee: Robert Luchetti Associates, Inc., Cambridge, MA (US)

(21) Appl. No.: 11/076,358

(22) Filed: Mar. 9, 2005

(51) Int. Cl. B60N 2/00

(52) U.S. Cl. 297/354.11

(57) ABSTRACT

A chair is configured to allow the effective seating area to be varied to accommodate a range of body sizes. One or more support arms pivotably support a backrest for translational movement while allowing the backrest to rotate relative to the seating surface. The combination of translational movement with rotational movement allows a greater or lesser amount of seating surface to be exposed depending on the size of the person using the chair. Movement of the backrest may be resisted at both pivot points using springs of differential strengths. Optionally, rotation of the default resting angle of the backrest may be synchronized with translation of the backrest. The chair may be designed to both stack and nest to enable it to be stored in a plurality of manners.

### BACKGROUND OF THE INVENTION

1. Field of the Invention

The present invention relates to chairs and, more particularly, to a variable sized chair with a self-adjusting chair back that can adjust to accommodate a range of sizes of persons.

2. Description of the Related Art

Chairs are common items that are used to support one or more persons while in a sitting position. The design of a chair may be dictated by many design considerations. For example, the chair design may be at least partially dictated by the intended use, and hence durability requirements. For example, a chair to be used in a public facility may need to be more durable than a chair designed to be used in a person's home or in an office environment. Additionally, the chair design may be affected by aesthetics, comfort features such as whether the chair should have arms and be able to recline, and whether the chair should be able to be stored during periods of non-use. Several common ways of storing chairs include folding in which the chairs are collapsed and either stacked on top of each other or placed next to one another, stacking in which chairs sit on top of each other in an un-collapsed fashion, and nesting in which the chairs fit together while remaining on the floor.

Chairs that are to be used by particular individuals may be made to be an appropriate size for that individual. For example, the chair may be made in several sizes and the particular person may order a chair configured to fit their body type. Chairs that are used by the general public, however, such as chairs designed to be used in educational institutions, should be able to accommodate a diverse range of body types. Particularly in the educational area, the body sizes of persons likely to use the chairs may vary considerably, given the different rates at which people mature and the concomitant size differences. Accordingly, it would be desirable to have a chair design with flexible storage options which could accommodate a range of body types in a comfortable manner.

### SUMMARY OF THE INVENTION

A chair with a self-adjusting chair back can adjust to accommodate a range of sizes of persons. In one embodiment of the invention, the chair back is designed to allow the effective seating area of the chair to be varied to thereby allow the chair to accommodate a large range of body sizes. The chair is provided with chair back configured to enable a backrest to move relative to the seating surface, to thereby expose a variable amount of seating surface depending on the size of the person using the chair. Chair back support arms may be supported at a proximal pivot point at a distance along the seating surface and configured to rotate about the proximal pivot point. A backrest is supported by the support arms a distance above the seating surface at distal pivot points on the support arms and configured to be rotatable about the distal pivot points. The combination of the proximal and distal pivot points enable the backrest to extend away from an area above the seating surface to allow more of the seating surface to be exposed, while allowing the backrest to be positioned at a relatively constant angle relative to the seating surface or at another angle according to the comfort of the user. Since the backrest angle may be varied relative to the supports and thus placed at an arbitrary angle or even maintained at a constant angle relative to the chair seating surface, moving the backrest allows additional seating surface area to be used to support the person using the chair to allow the person to sit back into the chair further than if the back was merely allowed to recline. This allows the chair to accommodate differently sized persons. Optionally, rotation of the backrest may be synchronized with translational movement to allow the neutral unbiased backrest angle to remain at a relatively constant value as the backrest is moved relative to the seating surface.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a block diagram of an example of a chair illustrating movement of the chair back relative to the seating surface according to an embodiment of the invention;

FIG. 2 is a block diagram of the chair of FIG. 1 with the seating surface raised according to an embodiment of the invention;

FIG. 3 is a block diagram of the chair of FIG. 1 illustrating the manner in which the neutral unbiased backrest position changes as the support arms are rotated relative to the seating surface according to an embodiment of the invention;

FIG. 4A is a block diagram of a chair in an erect position in which rotation of the neutral unbiased backrest angle is synchronized with translational movement of the backrest according to an embodiment of the invention;

FIG. 4B is a block diagram of the chair of FIG. 4A in a reclined position according to an embodiment of the invention;

FIG. 5 is a paraline exploded view of an example of a chair according to an embodiment of the invention;

FIG. 6 is a cross-sectional view of a mechanism for attaching chair legs to the chair support structure according to an embodiment of the invention;

FIG. 7 is a cross-sectional view of a mechanism for attaching additional features to one side of the chair support structure according to an embodiment of the invention;

FIGS. 8-10 are a cross-sectional views of a support structure for the chair in FIG. 5 taken along line A-A in FIG. 5 according to embodiments of the invention;

FIG. 11 is a cross-sectional view of the distal pivot point hinge assembly of the chair of FIG. 5 according to an embodiment of the invention;

FIG. 12 is a cross-sectional view of the proximal pivot point hinge assembly of the chair of FIG. 5 according to an embodiment of the invention;

FIG. 13 is a front view of a U-shaped wire spring that may be used in the spring assemblies according to an embodiment of the invention; and

FIGS. 14A-B, 15A-B, 16A-B, 17A-B, 18A-B, and 19A-B are sets of figures illustrating cross-sectional views taken along lines I-I and II-II in FIGS. 4A and 4B respectively. These figures illustrate the relative displacement of the support members as the chair back is reclined and illustrate several example cross-sections of elements that may be used to implement the support members according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, materials, and dimensions have not been described in detail so as not to obscure the invention.

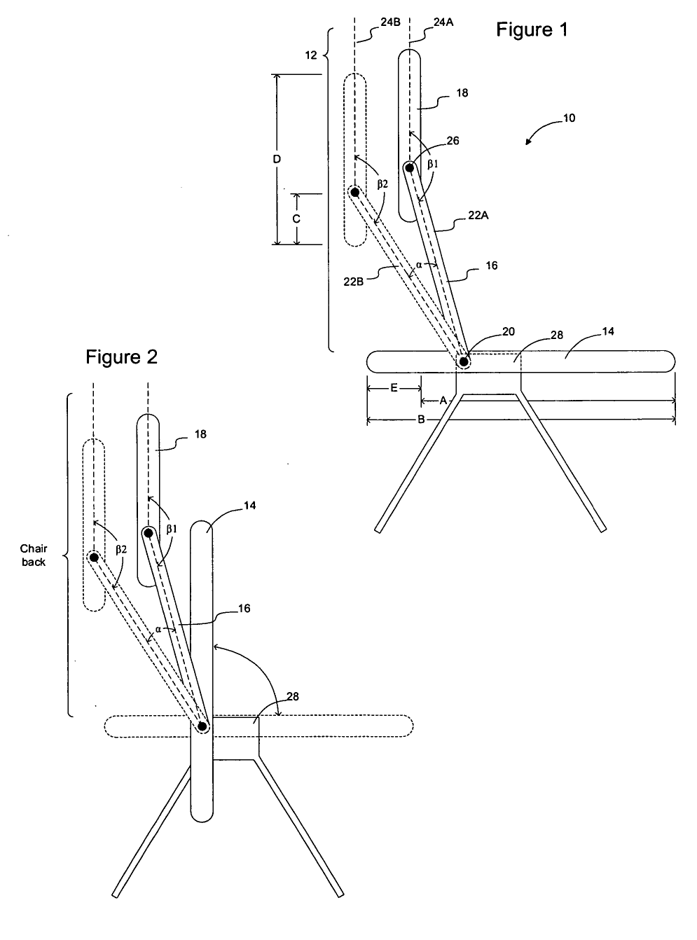

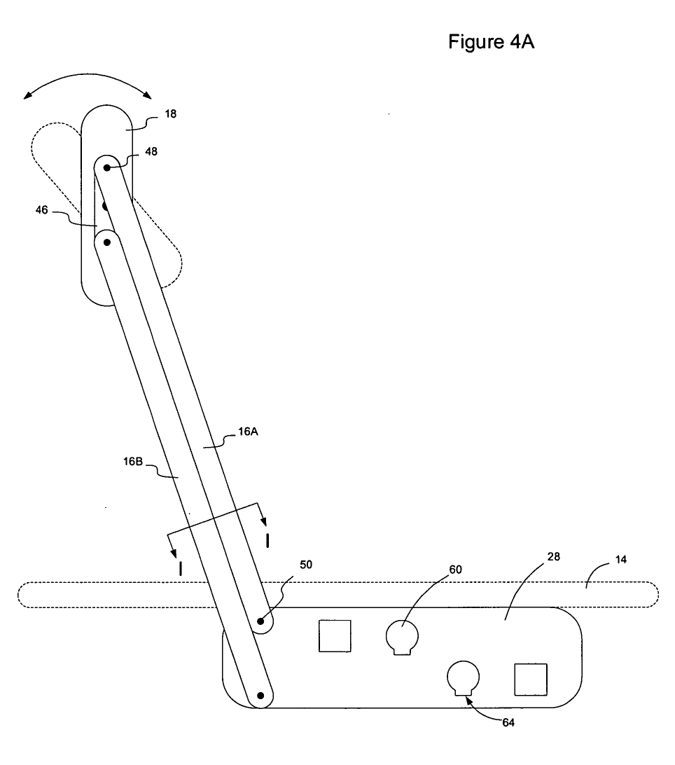

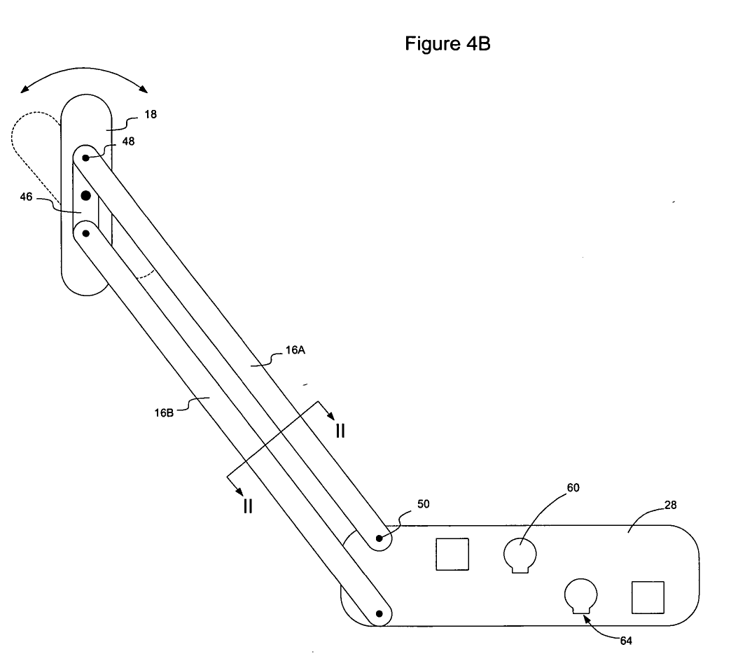

FIG. 1 is a block diagram of a chair 10 illustrating movement of a chair back 12 relative to a seating surface 14 according to an embodiment of the invention. As shown in FIG. 1, the chair 10 includes a chair back 12 having at least one support arm 16 configured to support a backrest 18. In the embodiments illustrated herein, a chair back having at least two support arms 16 is illustrated, one attached to each side of the backrest 18. The invention is not limited in this manner, however, as in other embodiments multiple support arms may be used on each side or a single support arm may be used. For example, an embodiment in which multiple support arms are provided on each side of the backrest is illustrated in FIGS. 4A-4B, and will be discussed in greater detail below.

The chair back 12, according to an embodiment of the invention, is configured to be supported at a proximal pivot point 20 disposed a distance A along the seating surface 14. Rotation of the support arms 16 about the proximal pivot point 20 allows the backrest 18 of the chair back 12 to be moved relative to the seating surface 14 between a first position and a second position to expose different amounts of the seating surface, depending on the size of the person using the chair. Specifically, as shown in FIG. 1, the proximal pivot point 20 allows the support arms 16 of the chair back 12 to be rotated from the first position 22A, through an angle a to the second position 22B or to an intermediate position at an angle between angles α and β. Rotation of the support arms causes the backrest 18 supported thereon to move from a first position 24A toward a second position 24B, relative to the seating surface, to allow more of the seating surface to be exposed as the backrest is pushed by the person sitting in the chair.

Specifically, as shown in FIG. 1, when the support arms are in the first position 22A, the backrest is supported in the first position 24A relative to the seating surface, so that a first expanse of seating surface A is available. This allows smaller persons with shorter legs to sit in the chair and receive support from the chair back while having their legs fit comfortably on the chair and have their thighs supported by the chair and back supported by the backrest. However, when the support arms 16 are rotated toward the second position 22B, the backrest is moved rearward over the top of the seating surface to expose a greater expanse of seating surface B. This allows a larger person, with longer legs, to receive support from the chair seating surface along a greater length of their thighs, thus increasing the comfort level of the chair for the larger person, while still allowing the larger person to receive adequate back support from the backrest.

The support arms may be configured to be able to continuously pivot, meaning that they may assume any angular position between the first position and the second position. Alternatively, an indexing mechanism may be used to allow the user to preferentially select between one or more of a plurality of angular positions intermediate 22A and 22B. Additionally, optionally a locking mechanism such as a handle may be provided to lock the support arms in position once a desired position has been selected by the chair user. For example, the indexing mechanism may have a handle that will allow the seat back to be locked at one of the possible indexes. This will allow the backrest to remain at a fixed position relative to the seating surface as the person using the chair leans forward in the chair. Other features may be provided as well and the invention is not limited to a chair that includes all of the particularly mentioned additional features.

Although the invention is not limited to a particular range of movement, according to an embodiment of the invention the angle α may be between 3° and 10°, and more particularly in the range of between approximately 5° and 7°. For support arms approximately 12 inches long, allowing a movement of 6° will allow the backrest to move toward the back edge of the of the seating surface approximately 1.25 inches. The distance over which the backrest may be displaced, and the amount of displacement associated with a particular angular movement of the support arms will depend on several design factors, such as the length of the support arms and the overall chair configuration. The invention is thus not limited to a particular selected range of motion of the support arms relative to the seating surface.

In addition to rotating about a proximal pivot point, the support arms are configured to support the backrest at a distal pivot point 26. Supporting the backrest at a pivot point allows the backrest to rotate independent of rotation of the support arms to increase the comfort level of the chair. Specifically, rotation of the support arms relative to the seating surface allows the backrest to translate, while rotation of the backrest relative to the support arms enables the backrest to conform to the user's back by assuming a comfortable angle according to the posture of the individual sitting in the chair. For example, if the user sits straight back in the chair, the user may cause the backrest to maintain a relatively constant angle relative to the seating surface as the backrest is moved relative to the seating surface. Specifically, as shown in the embodiment illustrated in FIGS. 1 and 2, the backrest 20 assumes a first angle PI relative to the support arms 16 when in the first position, and may be caused to assume a second angle β relative to the support arms 16 when in the second position. β 1 may be the same as β 2, or may be different according to the preference of the user. By enabling the backrest angle to be altered as rotation of the support arms causes the backrest to translate, the user may select a comfortable backrest position that conforms to that individual's preferred posture.

In the embodiment illustrated in FIG. 1, two support arms have been illustrated, one connected to each side of the backrest. As a person pushes back against the backrest, force from springs disposed at the pivot points where the support arms are connected to the support base will resist movement of the backrest. Where the person pushes against the backrest in the center of the backrest, the springs will contribute equally to resist the backwards force generated by the user. Where the user pushes more on one side of the backrest than the other, however, the backrest may tend to torque somewhat such that the force exerted by the springs on the support arms may tend to try to rotate the backrest 18 about a vertical axis relative to the chair's seating surface 14. While this may be desirable in certain situations, such as to allow the backrest to support the person's back while the person is sitting in the chair in an angled fashion, in other circumstances it may be desirable to design the chair back to avoid torquing motion.

Torque avoidance may be accomplished by synchronizing movement of the support arms relative to each other. For example, support arm movement may be synchronized by causing the support arms to be connected via one or more connecting rods. The connecting rods may be located at any place along the support rods and may be straight, curved, or may assume another shape. For example, a rod may be caused to extend through the center of rotation of the support arms at the proximal pivot point 20 to extend through the coil spring assemblies and tubes described below. Alternatively, the connecting rods may be located to extend through a portion of the backrest and optionally rotate along with the backrest. Many different ways of synchronizing movement of the support arms may be developed and the invention is not limited to a particular implementation of this feature.

The backrest may be biased around the distal pivot point to assume a neutral resting position when not being biased toward a different position by exertion of an user. For example, the neutral resting position of the backrest may be relatively vertical relative to the seating surface while the support arms are in the first position. When a user rests their back against the chair back, the application of force against the backrest will cause the backrest angle to change relative to the seating surface. To allow the backrest to be rotated by application of pressure from an user's back, the distal pivot point where the support arm is attached to the backrest is preferentially located a distance C along the length D of the backrest, so that the user may push against the portion of the backrest between the bottom edge and the distal pivot point as well as between the top edge and the distal pivot point. This provides a leverage arm relative to the spring to allow the user to exert force against the force provided by the spring(s) associated with the backrest pivot point. The leverage allows the user to cause the backrest to assume a desired angle to provide support to the user's back according to the user's preferred posture.

The distance C will depend on the strength of the spring at the distal pivot point and the overall dimensions of the chair. For example, the distance C may be between 20% and 100% of the length of the backrest D. The invention is not limited to the particular length of the distance C, but should be configured to be comfortable to persons using the chair. Preferably the distance C is between about 30% and 70% of the distance D so that there is an appreciable amount of backrest extending above and below the connection to the pivot point. This allows the angle of the backrest to be changed at will by the person using the chair, for example where the user may wish to recline.

The proximal pivot point may be attached to the seating surface a distance E from the back of the seating surface so that when the support arms are pushed into the second position, the front of the backrest is adjacent the end of the seat. This allows a person sitting on the seat to be fully supported when sitting farther back in the chair.

In the embodiment illustrated in FIGS. 1-2, the proximal pivot point is intermediate the front and rear edges of the chair. The invention is not limited in this manner as the proximal pivot point may be disposed at other locations as well. For example, if the support arms were attached to the rear edge of the seating surface, and configured to angle forward, less seating surface would be exposed while the support arms were angled forward and more seating surface may be exposed as the backrest is moved away from the front of the chair. This embodiment has the additional advantage that the backrest will be caused to raise upward away from the seating surface as it translates toward the rear edge of the chair (as the user sits back into the chair) due to the rotation of the support arms. Thus, in this embodiment, a larger person may be provided with an elevated backrest to accommodate their taller back. The invention thus encompasses many embodiments and the invention is not limited to merely the several illustrated embodiments.

The seating surface and backrest may be made of any conventionally available material, such as molded plastic, wood, metal, foam, gel, composite, or other conventional materials. Optionally, one or more of the surfaces may be covered by a padded layer covered with a suitable material such as a textile to make the chair more comfortable to its users. The invention is not limited to the particular type of materials used to create the seating surface and backrest, and is also not limited to any particular type of padding material or to the use of a padded seating or other surface.

As shown in FIG. 2, the seating surface may be designed to flip up for storage or when not in use, for example to allow the chairs to nest together by enabling the seating surface to rotate relative to the support assembly at a seating surface pivot point. The seating surface pivot point may be coincident with the position along the chair where the support arms join the seating surface, as shown in FIG. 2, or may be positioned at another location on the chair support structure 28. Optionally, the seating surface may be biased into the up position or biased into the down position using a spring assembly in a manner similar to the manner in which the support arms and backrest are biased into a predetermined position. The invention is not limited to the use of a biasing mechanism, however, as other mechanisms may be used to preferentially retain the seating surface in one or more predetermined positions.

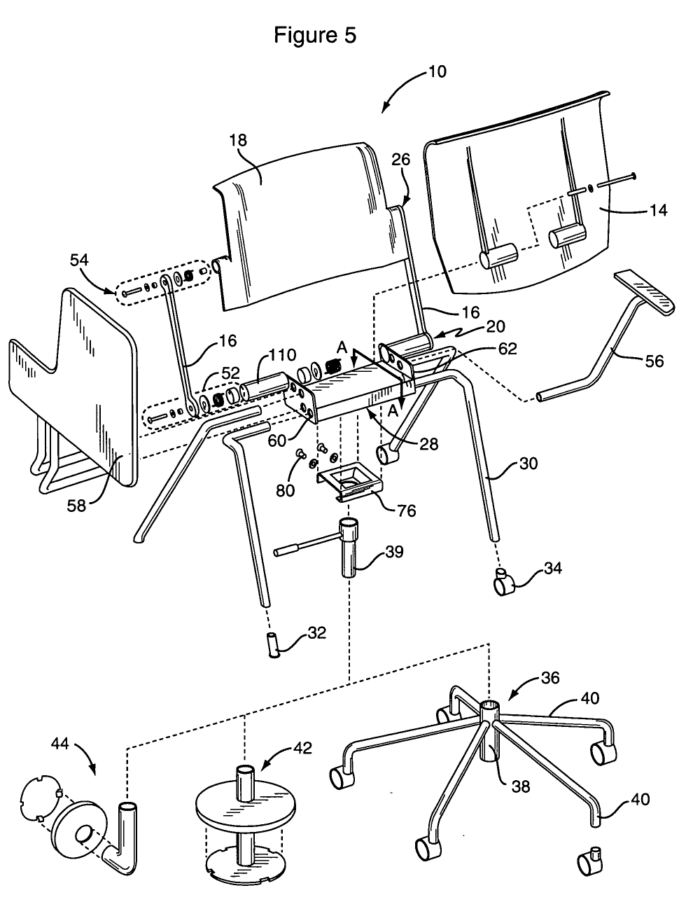

The chair may be supported by a suitable support structure 28, as shown in FIGS. 1 and 2, and a more detailed example of which is illustrated and described below in connection with FIG. 5. The invention is not limited to use with a particular support structure, however, as many different support structures may be used. The support structure may be connected to a plurality of different leg assemblies, such as a four angled legs 30, the sets of which may be changed to allow different length legs to be used with the same support structure, so that the same style chair may be provided with different seating surface heights depending on the particular classroom setting where the chair is intended to be used. The legs may have glides 32 on the ends to allow the legs to slide on the floor or may be provided with casters 34 to allow the chair to roll on the floor.

The leg assembly may take on other configurations as well, such as assuming a star base configuration 36 having a central post 38 and attached radially extending legs 40. Other configurations of the leg assembly include a fixed jury base 42 configured to allow the chair to be bolted straight into the floor, a riser mount 44 configured to allow the chair to be connected to a riser for example in an auditorium classroom setting, and a beam mount or stadium mount (not shown) which will allow one or more of the chairs to be mounted along a horizontal or relatively horizontal beam. Other bases may be used as well, and the chair may therefore be used with many different bases interchangeably.

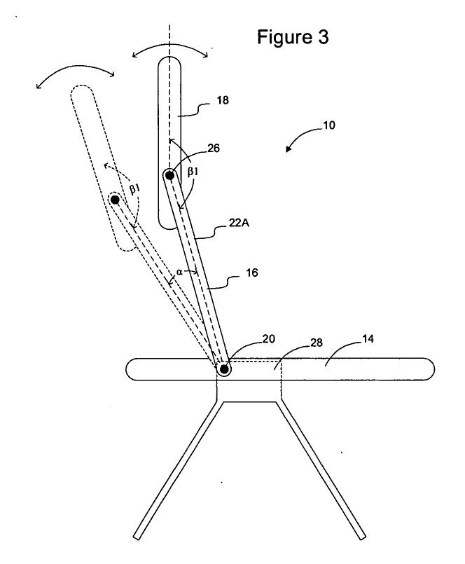

In FIGS. 1 and 2, the backrest is illustrated as having a relatively constant angle relative to the seating surface as the support arms are rotated relative to the seating surface. These figures were drawn in this manner to illustrate the translational motion of the backrest relative to the seating surface. Maintenance of a relatively constant angle is based on an assumption that the user will cause the backrest to move in that manner. FIG. 3 illustrates the neutral position of the backrest as the support arms are rotated relative to the seating surface. As shown in FIG. 3, as the support arms are rotated relative to the seating surface, the neutral unbiased position of the backrest relative to the support arms will also rotate, thus causing the backrest to naturally assume a different angle relate to the seating surface.

According to another embodiment of the invention, the backrest movement relative to the seating surface may be synchronized with movement of the support arms relative to the seating surface, such that the backrest pivot point will maintain a relatively constant neutral unbiased angle relative to the seating surface as the backrest moves relative to the seating surface. In this embodiment, a linking mechanism may be provided, such as a push rod, a cable, or two or more support arms, to coordinate movement of the backrest pivot point relative to the seating surface. Alternatively, the backrest may be supported in an unbiased manner and gravity may be used to cause the backrest to remain relatively vertical when not engaged with an user's back.

By synchronizing or maintaining the angular orientation of the backrest pivot point relative to the seating surface, the springs biasing the backrest relative to the support arms may be configured to bias the backrest in the same way regardless of the orientation of the support arms relative to the seating surface. This allows translational movement of the backrest to occur without concomitant rotational movement of the backrest as the backrest is moved away from the front edge of the chair.

One way to synchronize movement of the pivot point of the backrest is to use a plurality of support arms on each side of the backrest. This embodiment is illustrated in FIGS. 4A and 4B. As shown in FIGS. 4A-4B, two support arms 16A, 16B of the same length are attached at equal intervals to the support structure 28 and to a backrest pivot plate 46 configured to carry the pivot assembly for the backrest 18. By attaching the equal length support arms at equal intervals to respective structures on both their top and bottom end, rotational movement of the arms will cause the backrest pivot plate 46 to maintain a constant angular orientation relative to the seating surface. This is illustrated, for example in FIG. 4A where the backrest is relatively forward and FIG. 4B where the backrest has been pushed backward away from the front of the seating surface. Note that in these two figures, the angle between the backrest pivot plate 46 that carries the pivot point for the backrest maintains the same angle relative to the support structure.

By carrying the backrest pivot point on a backrest pivot plate 46, it is possible to allow the two arm sections 16A, 16B forming a given support arm to both provide support to the backrest. Additionally, by maintaining the piece supporting the backrest at a constant angle, the neutral unbiased backrest angle will be maintained relatively constant relative to the seating surface, to thereby cause the back of the chair to feel the same for users of different sizes. By adjusting the spacing of the attachment points 48, by adjusting the separation distance of the attachment points 50 to the support structure 29, or by adjusting the length of the arms relative to each other, the neutral unbiased angle of the backrest may be caused to vary in a desired manner. The invention is thus not limited to this particular example in which two arms are used to maintain a constant angle as the synchronization mechanism may be used to cause the neutral unbiased angle to vary in any desired manner.

In the embodiment illustrated in FIGS. 4A and 4B, the synchronizing mechanism is illustrated as encompassing two support arms. Other synchronizing mechanisms maybe used as well and the invention is not limited to an embodiment that relies on two support arms to synchronize rotational movement of the backrest with translational movement of the backrest. For example, another type of linking mechanism may be used such as an internal wire rod connected eccentrically at the ends from the support arm pivot points, an internal sprocket chain assembly, an internal perforated high-strength plastic tape connected around sprockets associated with either pivot point, a push rod, or another similar synchronizing mechanism. Thus, many different synchronizing mechanisms may be used and the invention is not limited to the particular illustrated embodiment.

FIG. 5 illustrates an exploded view of one embodiment of a chair that may be configured to implement an embodiment of the invention, and particularly shows additional details of the support structure 28 and spring assemblies 52, 54 that may be used at the proximal pivot points 20 and distal pivot points 26. As shown in FIG. 5, the chair 10 has a seating surface 14 configured to be attached to a support structure 28. In the embodiment illustrated in FIG. 5, the seating surface is configured to be pivotable relative to the support structure 28 so that the chairs can nest into each other for storage in a manner similar to the embodiment illustrated in FIG. 2. The invention is not limited in this manner, however, as a fixed seating surface may be used as well.

The support arms 16 are configured to be attached to the support structure at a position along the seating surface to allow the backrest 18 carried on the support arms to translate relative to the support structure and, hence, relative to the seating surface. In the illustrated embodiment, the support arms 16 are configured to be attached to the support structure coincident with the point of attachment of the seating surface. The invention is not limited in this manner, however, as the support arms may be mounted at any suitable place on the support structure.

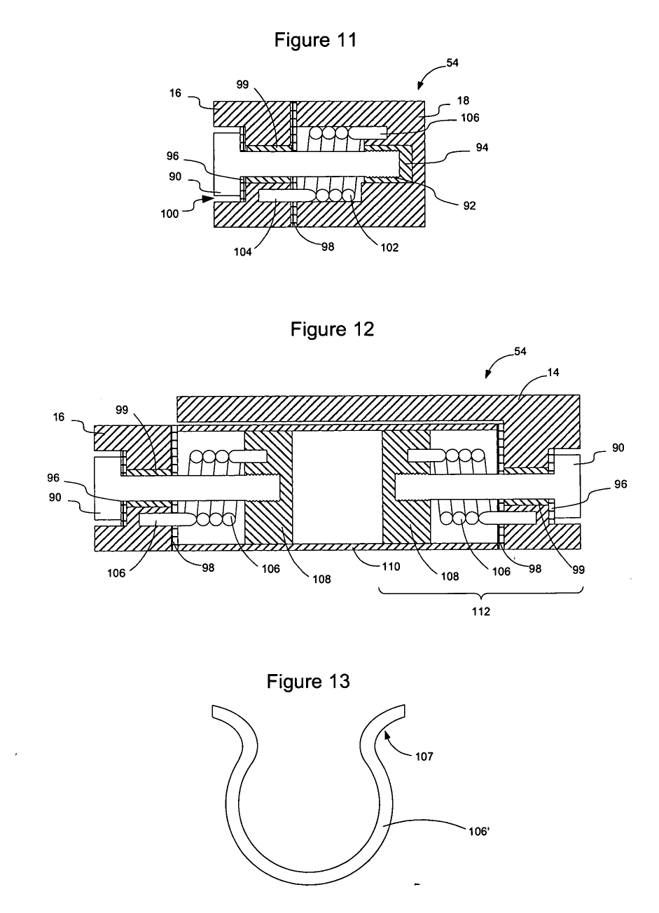

A proximal spring assembly 52 and a distal spring assembly 54 are provided to bias the support arms and backrest in an appropriate manner as discussed herein. Additional detail regarding the spring assemblies 52, 54 will be provided below in connection with FIGS. 11 and 12. Relative spring values for use in the spring assemblies 52, 54 may be selected depending on the particular implementation, and may depend for example on the final length of the support arms, the weight of the components of the chair back, and frictional forces that need to be overcome in connection with movement of the parts relative to each other. Accordingly, the invention is not limited to any particular range of K-values for the springs described herein.

Although coil springs are illustrated in the figures, such as FIGS. 5, 11, and 12, in connection with the spring assemblies 52, 54, the invention is not limited to the use of coil springs as other types of springs may be used in the spring assemblies as well. For example, as shown in FIG. 13, a wire spring 106 having an approximate U-shape may be used, in which ends 107 are provided to engage mating posts associated with the parts to be biased relative to each other. Other types of springs, such as leaf springs, may also be used as well. Thus, the depiction of a coil spring is to be taken as illustrative and not limiting of the invention. Accordingly, the invention is not limited to any spring configuration for uses in the spring assemblies.

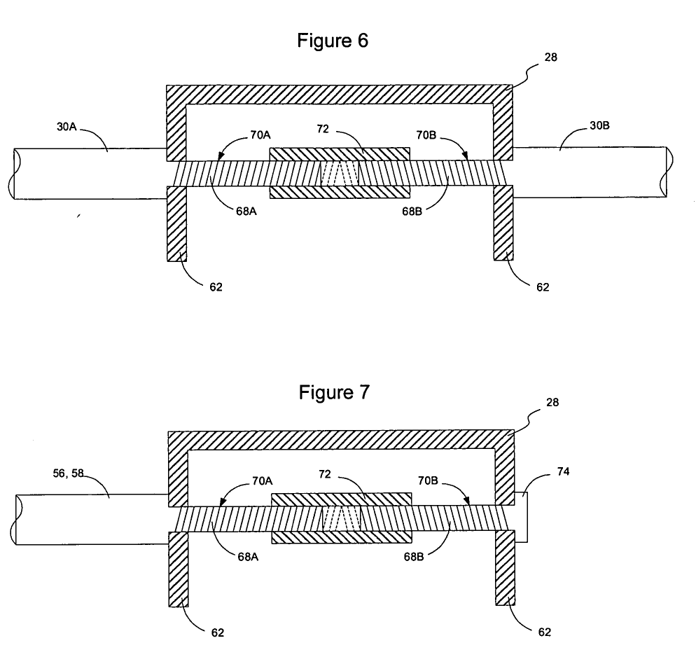

The chair may be adorned with additional features, such as an arm rest 56 and/or a tablet desk 58. These additional features may attach to the support structure 28 in an appropriate manner. The invention is not limited to a chair including these additional features to the manner in which the additional features are attached to the chair. Additional details associated with one possible way of mechanically attaching the legs and additional features to the support structure will be provided below in connection with FIGS. 6-7, although the invention is not limited to the use of this illustrated mechanical attachment mechanism.

As shown in FIG. 5, the support structure may be configured to accommodate multiple types of leg assemblies. For example, apertures 60 may be formed in side panels 62 of the support structure 28 so that individual leg assemblies may be welded or mechanically attached to the chair. These legs 30 may be welded into the apertures or may extend through the apertures and be connected together, for example by welding or using a turnbuckle configured to engage threaded extensions on the legs. An example illustrating use of a turnbuckle to mechanically attach the legs is illustrated below in connection with FIG. 6. Where the legs extend through the apertures, the apertures may be formed to be square (as shown in FIGS. 4A and 4B) or assume another shape designed to prevent rotation of an appropriately conformally shaped leg end relative to the chair base. Alternatively, where the leg end is round and a generally round hole is used to receive the leg end, an extended area of the aperture may be sized to receive key structure 64 to engage the leg and prevent the leg from rotating relative to the aperture once inserted. An example of an aperture configured to enable keyed engagement between a round leg and primarily round hole is illustrated in FIGS. 4A and 4B. Where an arm assembly 56 and/or tablet desk 58 is to be attached to the support structure, a similar attachment mechanisms may be used. Where the legs are to be welded to the support structure 28, the strength of the weld may be sufficient to prevent the chair legs from rotating relative to the chair base so that round holes and round leg profiles may be employed.

The legs may be attached to the support structure by welding or otherwise permanently attaching the legs to the support structure. Alternatively, the legs may be made to e mechanically attachable to the support structure to enable the legs to be field applicable. Where the support structure 28 is sufficiently rigid to withstand lateral bending forces generated by the legs, the legs may be bolted or otherwise attached to one side of the support structure. Alternatively, to prevent the support structure from being required to withstand the forces generated by the legs when a person sits in the chair, the legs may be connected to each other through the apertures to allow the forces to be absorbed by the legs rather than the support structure.

FIG. 6 illustrates a turnbuckle mechanism that may be used to connect legs 30 to each other through apertures 60 in the sides 62 of the chair support structure 28. FIG. 7 illustrates a similar turnbuckle mechanism that may be used to attach a tablet desk or arm to one side of the support structure. The invention is not limited to the use of these illustrated mechanisms. In the embodiment illustrated in FIG. 6, the support structure 28 is configured to have apertures 60 on either side panel 62 to receive threaded rods 68A, 68B, that are welded or otherwise attached to legs 30A, 30B. In this instance, threads 70A on the rod associated with the left leg 30A are left-hand threads and threads 70B on the rod associated with the right leg 30B are right-hand threads. A turnbuckle 72 is provided with a cavity defined there-through with right-hand threads on the right side and left-hand threads formed on the left side. The counter-threaded portions of the turnbuckle threadably engage the threaded rods 68A, 68B, to pull the legs 30A, 30B snug against the side panels 62 of the support structure 28. Alternatively, the insides of the left and right legs 30A, 30B, may be threaded in opposite directions and a turnbuckle with threads on its outer surface may be used to engage the legs and pull the legs into engagement with the support structure 28. Other methods of mechanically attaching the legs may be used as well and the invention is not limited to an embodiment in which a turnbuckle is used.

Where an arm rest 56 or tablet desk 58 is to be attached to one side of the chair, a mating post 74, such as the post illustrated in FIG. 7, may be inserted through an aperture 60 in the support structure 28 opposite the aperture 60 used to receive the arm rest or tablet desk, so that the arm rest or tablet desk may be attached using a turnbuckle mechanism 72 in a manner similar to that described above with respect to the legs. Specifically, since a turnbuckle relies on engagement with oppositely threaded posts, to allow a turnbuckle to be used to connect an arm rest or other accessory to only one side of the support structure, it is necessary to provide a threaded rod 68 to engage with the turnbuckle 72. By providing a post 74, the turnbuckle attachment mechanism may be used to attach the additional features as well as the legs to the chair, to thereby reduce the number of parts required to be manufactured to attach various pieces to the support structure. One benefit to enabling mechanical attachment of the parts is that the chairs may be field assembled and modified once installed to allow the configuration of the chair to change as the use to which it is put changes.

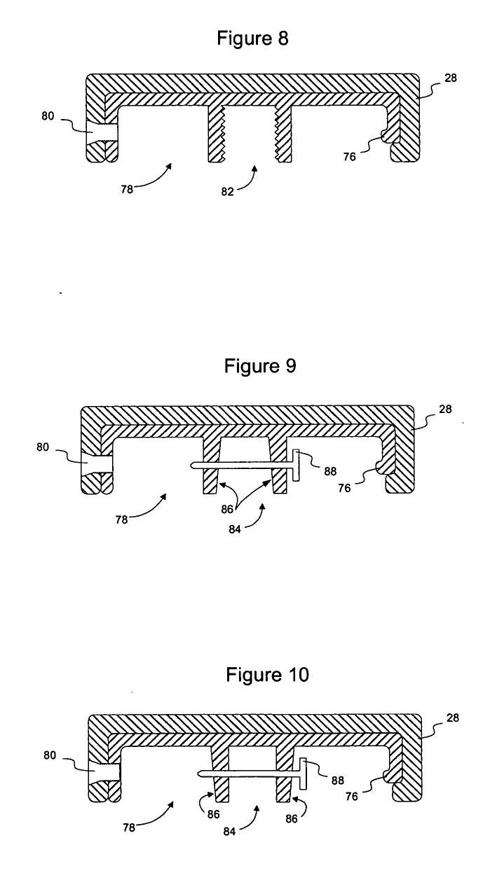

As shown in FIG. 5, the support structure may be configured to connect to a flanged coupling 76 to allow the chair to be connected to a star base 36, jury base 42, riser base 44, stadium base (not shown), or other alternatives to individual chair legs. For example as shown in FIG. 5 and as illustrated in greater detail in FIGS. 8-10, the support structure 28 may have a recessed area 78 configured to accept a mating flanged coupling 76 to allow the support structure 28 to be attached to a post 38 associated with or configured to be received by the star base 36 or one of the other illustrated bases, or to a structure 39 configured to fit within the post 38. The flanged coupling 76 and support structure 28 may be joined using one or more bolts 80, or using another conventional mechanical mechanism.

The flanged coupling may be attached directly to the post associated with the alternative base or, alternatively, may be connected to a post 39 designed to be received in the post 38 of the base. The term “post” will be used herein to refer generically to either of these structures unless clarified to be particular to one of them.

The flanged coupling may take on many forms, depending on the manner in which the post is designed to be mated to the flanged coupling 76. For example, where the post and flanged coupling 76 are designed to have a threaded engagement as shown in FIG. 8, a threaded receptacle 82 may be formed on the flanged coupling 76. The threaded receptacle may be a female receptacle as illustrated carrying a threaded surface on the inside, or may be a male receptacle carrying a threaded surface on the outside. The invention is not limited by this particular detail.

Alternatively, as shown in FIGS. 9 and 10, the flanged coupling 76 may be provided with a tapered receptacle 84 having angled engagement surfaces 86 and designed to form a frictional pressure fit with the post. In this embodiment, when the post is pushed into the tapered receptacle (in the embodiment of FIG. 9) or pushed over the tapered receptacle (in the embodiment of FIG. 10) frictional engagement between the tapered surfaces and the post will cause a snug attachment between the flanged coupling and the post. Optionally, a pin 88 disposed through appropriately configured apertures may be used to secure the attachment of these parts.

Although several mechanical attachment mechanisms have been illustrated, the invention is not limited in this manner as the post 38 and flanged coupling 76 may also be permanently connected by welding, brazing, soldering, using an adhesive, or using other techniques. When permanently attached in this manner, depending on the design of the parts, the use of a receptacle on the flanged coupling 76 may not be necessary. The invention is thus not limited to the manner in which these two parts are connected. For example, the flanged coupling could be welded to the post 38 forming part of the base or configured to be inserted into a mating receptacle in the star base, and thus be formed integral with the post 38 associated with the base to enable the base to be connected directly to the support structure. By welding the same flanged coupling to the several types of bases described above, the same support structure and, hence, seating surface may be used interchangeably with all of the several bases.

Where the seating surface is to be tiltable relative to the floor, the flanged coupling may be disposed on top of a seat base tilt mechanism such that the seat base tilt mechanism is interposed between the flanged coupling 78 and base to allow the seating surface to tilt relative to the post 38 and, hence, relative to its leg assembly. The invention is not limited to use with a seat tilt mechanism or to the use of a particular type of seat tilt mechanism.

FIG. 11 illustrates an embodiment of a distal pivot point 26 hinge and spring assembly 54 that may be used in connection with an embodiment of the invention. Although particular details will be provided about the distal hinge assembly, the invention is not limited to use of this particular hinge assembly as other hinge assemblies may be used as well.

In the embodiment shown in FIG. 11, the support arm 16 is connected to the backrest 18 by a bolt 90. The bolt 90 may be any conventional bolt, preferably carrying threads 92 on at least a distal portion to allow it to engage a bushing 94 that has been pressure set, adhered, or otherwise inserted into the backrest 18. Where the backrest 18 is formed of sufficiently strong material, the bushing may be eliminated. To allow relative movement between the backrest 18 and support arm 16, washers 96, 98 may be provided between the head 100 of the bolt 90 and support arm 16, and between the support arm 16 and the backrest 18 respectively. Additionally, a sleeve 99 may be provided at the interface between the bolt 90 and the support arm 16. The washers and sleeve may be made of any suitable material, but in a preferred embodiment the washers are made of a relatively slippery material such as Nylon or Teflon™.

To enable the backrest to be biased against movement, while allowing a range of movement, a spring 102 is disposed around the bolt 90 with extending legs 104, 106, configured to extend into respective apertures in each of the support leg 16 and backrest 18. Where the material forming the backrest or leg is not strong enough to retain the respective extending leg, a suitable metal bushing (not shown) may be included to reinforce the material at that point. By adjusting the strength of the spring, different tensions may be provided between the backrest 18 and support arms 16. Optionally, strong stops may be provided as well to limit the range of movement of the backrest 18 relative to the support arms 16 to prevent the spring from being damaged by over-rotation, for example if a user were to sit on the top of the backrest.

FIG. 12 illustrates an assembly 52 configured to enable the support arms 16 to rotate relative to the seating surface 14 at the proximal pivot point 20 and, in this embodiment, to allow the seating surface 14 to rotate relative to the support tube 110 associated with support structure 28. As shown in FIG. 12, the spring assembly 52 for use at the proximal pivot point is similar to the spring assembly used at the distal pivot point, although the invention is not limited in this manner. However, since the spring 106 used at the proximal pivot point spring assembly 54 is configured to provide force against movement of the backrest away from the seating surface, in one embodiment, the spring used in the proximal pivot point spring assembly 54 may be relatively stronger than the spring used in the distal pivot point spring assembly 52. To accommodate this, a bushing 108 is inserted inside a metal tube 110 that is connected, directly or indirectly, to the support structure 28. The bushing 108 may be attached to the tube 110 such as by a compression fitting, soldering, brazing, welding, or via another common method, or may be or may be formed integral with the tube. Providing a metallic interface between the spring 106 and the support structure 28 provides the spring with a secure attachment point to allow a relatively strong spring to be used at the proximal pivot point 20. Other components of the spring assembly are the same as the spring assembly described above in connection with FIG. 5, and hence will not be described in greater detail herein.

Additionally, as shown in FIG. 12, where the seating surface 14 is to pivot to allow the seating surface to be flipped up for nested storage, a similar spring-biased assembly 112 may be used to attach the seating surface 14 to the tube 110 of the support assembly 28. Using the same assembly with different spring strengths to attach the backrest to the support arms, the support arms to the support assembly, and the seating surface to the support assembly, minimizes the number of different parts that must be designed and individually manufactured and, hence, may minimize costs associated with manufacturing the chair. The invention is not limited in this manner, however, as differently sized and configured assemblies may be used in each of these locations.

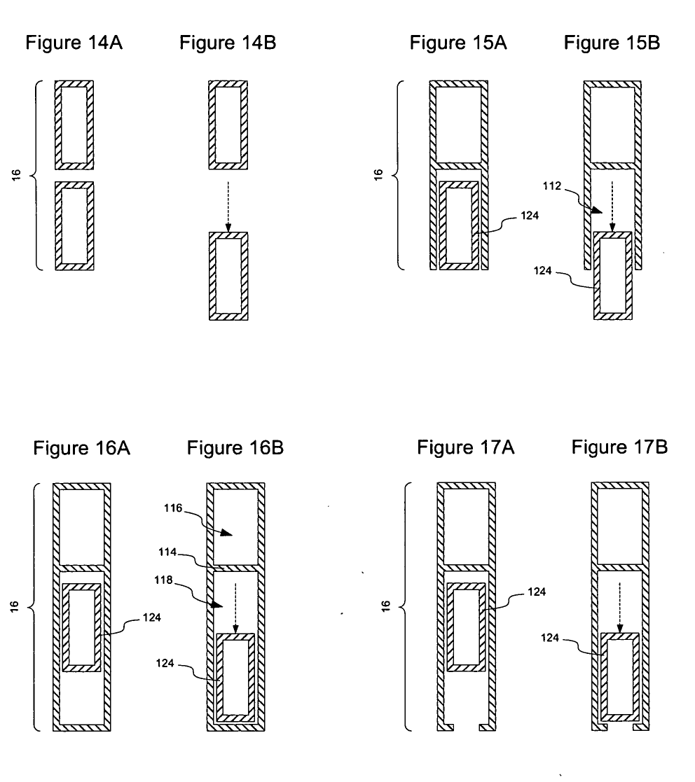

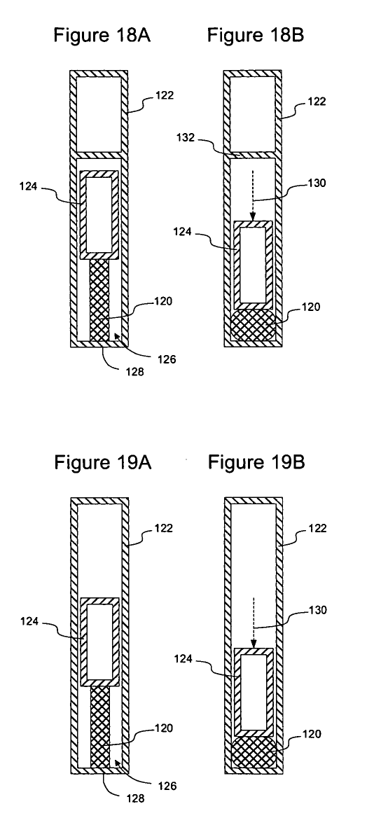

Referring back to FIGS. 4A and 4B, when two support arms 16A, 16B are used to support the backrest, movement of the backrest away from the seating surface causes the two support arms to move relative to each other. In the illustrated embodiment the two support arms move away from each other, although differently configured support arms may be caused to move toward each other, depending on the geometry of the support arms and the manner in which the arms are connected to the backrest pivot plate 48 and support structure 28. Pairs of FIGS. 14A-14B through 19A-19B illustrate several cross-sectional views taken along lines I-I and II-II from FIGS. 4A and 4B. These views show movement of the bars relative to each other as well as illustrate several different cross-sections that may be used to form the support arms. The invention is not limited to an embodiment in which the arms are configured to implement one or more of the illustrated cross-sections as other cross-sections may be used as well.

In the embodiment illustrated in FIGS. 14A-14B, each of the support arms has a similar cross-section. Specifically, in the embodiment illustrated in FIGS. 14A-14B, each support arm has a rectangular cross-section. Other similarly shaped cross-section support arms may be used as well, such as support arms having round cross-sections, oval-shaped cross-sections, or other cross-sectional shapes. As the backrest is moved from the position in FIG. 4A (illustrated in cross-section in FIG. 14A) to the position in FIG. 4B (illustrated in cross-section in FIG. 14B) the two support arms move away from each other.

Movement of the two support arms relative to each other may, if the support arms are sufficiently close, present the potential to pinch an user of the chair. To avoid this, or purely for aesthetic reasons, one of the support arms may be channeled within the other one or may be caused to be fully disposed within an interior cavity of the other support arm. For example, in the embodiment illustrated in FIGS. 15A-15B, one of the support arms has a channel 112 formed at one side to receive the other support arm. By causing an inner support arm 124 to be at least partially received within the channel as the arms move relative to each other, the gap between the support arms may be covered to reduce the possibility of pinching. The arrow illustrates movement of support arms away from each other as the backrest is moved from the position in FIG. 4A to the position illustrated in FIG. 4B.

FIGS. 16A-16B illustrate an embodiment in which one of the support arms is fully retained in a cavity within the other support arm. In this illustrated embodiment, an inner wall 114 separates the interior of the larger outside support arm into two distinct portions 116, 118. The invention is not limited in this manner, however, as the outer support arm may be formed without this inner wall 114.

FIGS. 17A-17B illustrate an embodiment similar to that illustrated in FIGS. 16A-16B, except that a portion of the chamber 118 configured to receive 118 the smaller support arm has been eliminated to form a partially open channel.

Movement of the support arms relative to each other may be resisted by an appropriate material 120 disposed within the larger of the support arms 122 such that as the smaller support arm 124 moves within the larger support arm, the relative movement will cause the material 120 to be compressed. For example, as shown in FIGS. 17A-17B, a gelatinous substance or compressible rubber material may be inserted into the channel 126 between the inner support arm 124 and an end 128 of the outer support arm 122. As the chair is reclined and the support arms move away from each other in the direction of the arrow 130, the inner support arm 124 will impinge on the compressible material 120 to cause it to deform. The deformation may be used to resist backwards movement of the backrest relative to the chair's seating surface to thereby reduce or eliminate the need to use springs at the proximal pivot point where the support arms are attached to the chair base. FIGS. 19A-19B illustrate an embodiment similar to that illustrated in FIGS. 18A-18 B except that the bisecting wall 132 of FIGS. 18A-18B has been omitted. Accordingly, additional discussion of the embodiment of FIGS. 19A-19B will be omitted.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A chair with a self-adjusting chair back, said chair comprising:
a seating surface; and
a self-adjusting chair back having a plurality of support arms pivotably disposed relative to the seating surface and a backrest pivotably carried on the support arms to be pivotable relative to the support arms.

2. The chair of claim 1, wherein pivoting of the support arms relative to the seating surface effects translation of the backrest relative to the seating surface to expose differential amounts of seating surface to an user of the chair.

3. The chair of claim 2, wherein pivoting of the backrest as the support arms pivot enables the chair to adjust to an user's posture.

4. The chair of claim 1, further comprising a proximal spring assembly configured to bias the support arms rotationally relative to the seating surface.

5. The chair of claim 4, wherein the support arms are carried at a proximal pivot point at a location along the seating surface, and wherein the proximal spring assembly is disposed at the proximal pivot point and configured to bias the support arms toward a predetermined angular direction relative to the seating surface.

6. The chair of claim 4, further comprising a distal spring assembly carried on at least one of the support arms and backrest and configured to bias the back rest rotationally relative to the support arms.

7. The chair of claim 6, wherein the backrest is biased into a neutral position relative to the support arms.

8. The chair of claim 1, further comprising a linking mechanism configured to synchronize pivoting of the backrest with pivoting of the support arms.

9. The chair of claim 8, wherein the linking mechanism comprises two support arms configured to attach to one side of the backrest.

10. The chair of claim 9, wherein the two support arms are disposed such that one support arm resides at least partially within the other support arm.

11. The chair of claim 9, wherein the linking mechanism further comprises a backrest pivot plate configured to carry the backrest pivot point, and wherein the linking mechanism is configured to maintain an angular disposition of the backrest pivot plate relatively constant as the support arms are pivoted relative to the seating surface.

12. The chair of claim 1, further comprising legs configured to enable the chair to stack on top of other similarly configured chairs.

13. The chair of claim 1, further comprising legs configured to enable the chair to nest with other similarly configured chairs.

14. The chair of claim 13, wherein the seating surface is pivotable relative to the legs to facilitate nesting of the chair with other similarly configured chairs.

15. A method of enabling a differential amount of seating surface to be provided to users of a chair, the method comprising the steps of:
providing a chair having a backrest pivotably carried on a plurality of support arms;
rotating the support arms relative to the seating surface to cause the backrest to translate relative to the seating surface; and
rotating the pivotable backrest relative to the support arms to adjust an angle of the backrest relative to the support arms.

16. The method of claim 15, wherein the step of rotating the pivotable backrest relative to the support arms comprises adjusting the angle of the backrest relative to the support arms such that the angular position of the backrest remains relatively constant relative to the seating surface.

17. The method of claim 16, wherein the steps of rotating the support arms and rotating the pivotable backrest are synchronized.

18. A chair assembly, comprising:
a seating surface;
a chair back having a backrest movable between a first position relative to the seating surface and a second position relative to the seating surface, said backrest being capable of assuming a first angle relative to the seating surface in the first position and being capable of assuming the first angle relative to the seating surface in the second position.
